(19) United States
(12) Patent Application Publication
(10) Pub. No.: US 2007/0151665 A1
(43) Pub. Date: Jul. 5, 2007

(54) Unsupported thin-film container label

(76) Inventors: Edward Wiegand, Philadelphia, PA (US); Ulrich E. Weyermann, Bethany Beach, DE (US); Neal E. Langseder, New Canaan, CT (US)

Correspondence Address: Jane Massey Licata;Licata & Tyrrell P.C., 66 E. Main Street, Marlton, NJ, 08053, US

(21) Appl. No.: 11/620,097

(22) Filed: Jan. 5, 2007

Related U.S. Application Data
(60) Provisional application No. 60/757,096, filed on Jan. 5, 2006.

(51) Int. Cl. B41M 5/00; C09J 5/02

(52) U.S. Cl. 156/324.4; 428/195.1

(57) ABSTRACT

The present invention involves containers and their method of manufacture. More specifically the invention relates a preprinted, unsupported, thin-film label for direct application to a container. The invention also provides a system and method for applying a thin-film label to the container surface.

### INTRODUCTION

This application claims the benefit of U.S. Provisional Application No. 60/757,096, filed Jan. 5, 2006, which is herein incorporated by reference in its entirety.

### BACKGROUND OF THE INVENTION

A squeeze tube is a flexible cylindrical package with one closed end and one open end. The package is filled with a nozzle through the open end and then sealed on a machine designed for filling tubes. The closed end is usually fitted with a threaded portion and a cap which screws onto the thread. The product within the tube is dispensed by opening or removing the cap.

Methods for making squeeze tubes are known. For example, squeeze tubes can be extruded or blow-molded directly from polyolefin resins into the finished shape. Alternatively, squeeze tubes can be made from flat web stock which is rolled and welded to create the cylindrical shape with a side seam. Still further, aluminum tubes are produced by impact extrusion from an aluminum slug into the cylindrical shape.

Tubes are generally decorated by directly printing on the surface of the container, either in the round form or in the case of a side-seamed tube they are decorated by printing the flat web stock. Alternatively, tubes are decorated by transfer printing. In this method, the decoration is first printed on a separate web. In a separate process, the ink only is transferred by pressure and sometimes using heat, in a rolling operation, onto the round tube or onto the flat web (in the case of a side-seamed tube). In another method, a pre-printed pressure-sensitive label, which is carried on a secondary supporting material (usually PET), is peeled from the carrier and applied to the outer surface of the round tube. The pressure-sensitive label material is pre-coated with tacky adhesive which bonds the label to the tube surface. The adhesive is protected prior to application by the carrier material. In still another method, a thin film is applied to a secondary carrier material then printed and adhesive-coated. A tertiary material is applied over the adhesive to protect it. The tertiary material is removed during dispensing and the thin label is rolled onto the cylindrical tube body separating it from the carrier material.

### SUMMARY OF THE INVENTION

The present invention is an unsupported, preprinted, thin-film label for direct application to a container.

The present invention is also a method and system for producing a container with a label. The system employs a means for providing a label of the invention, a means for providing a container, and a means for applying or activating a bonding agent at the point of application of the label to the container so that the label, when contacted with the container, adheres to the container thereby labeling the container. Use of the system of the invention involves applying or activating a bonding agent at the point of application of the label to a container and contacting the label to the container thereby producing a container with a label.

### BRIEF DESCRIPTION OF THE DRAWINGS

FIG. 1 depicts an activation/application system for directly applying an unsupported thin-film label onto the surface of a tube, wherein the bonding agent is applied or activated on the label.

FIG. 2 depicts an activation/application system for directly wrapping an unsupported thin-film label onto a continuous extruded tube body, wherein the bonding agent is applied or activated on the label.

FIG. 3 depicts an activation/application system for directly applying an unsupported thin-film label onto a flat web stock, wherein the bonding agent is applied or activated on the label.

FIG. 4 depicts an activation/application system for directly applying an unsupported thin-film label onto the surface of a tube, wherein the bonding agent is applied or activated on the tube.

FIG. 5 depicts an activation/application system for directly wrapping an unsupported thin-film label onto a continuous extruded tube body, wherein the bonding agent is applied or activated on the tube body.

FIG. 6 depicts an activation/application system for directly applying an unsupported thin-film label onto a flat web stock, wherein the bonding agent is applied or activated on the web stock.

### DETAILED DESCRIPTION OF THE INVENTION

An unsupported thin-film label has now been developed which is preprinted for direct application to the outer surface of a container creating a decorated, labeled container for consumer products. Containers which can be labeled in accordance with the instant method include, but are not limited to, squeeze tubes, squeeze bags, pouches, jars, bottles, cans and like for use in packaging and dispensing non-solid consumer products such as fluid or fluidized materials, including liquids, pastes, powders, and the like. Squeeze tubes, pouches or bags and squeezable bottles are flexible packages made from plastic material (e.g., low or high density polyethylene, polypropylene, polyethylene terephthalate, polyvinyl chloride, softouch, dual layer, or coextruded plastics), elastic material (e.g., silicone, thermoplastic elastomer, natural rubber, or synthetic rubber such as isoprene), laminate materials (ethylene vinyl alcohol resin), or combinations thereof with one open end and one closed end. In particular embodiments, the container is a squeeze tube, pouch or bag formed by sealing a filled tube at one end resulting in a package with a cylindrical, open end and a flattened, closed end (e.g., a toothpaste tube or juice pouch).

The term label is used herein in the conventional sense to refer to a tag attached with adhesive to a surface so as to identify the object or its contents. A label of the instant invention is affixed to the surface of a container (i.e., not a component of the container itself) to provide product identifiers, product source/manufacturer identifiers, bar codes, nutritional information, decoration, and the like. A label of the invention is made of single or multiple layers of thin-film of any suitable material including paper, metal or plastic commonly employed in labels of consumer products. In particular embodiments, the label is a single layer of thin-film. Examples of thin-film plastics for use in accordance with the instant invention include, polyethylene film, polypropylene film, polyfluoroethylene film, polyvinylidene fluoride film, polyvinyl chloride film, polyvinylidene chloride film, ethylene-vinyl alcohol film, polyvinyl alcohol film, polymethyl methacrylate film, polyether sulfone film, polyamide film, tetrafluoroethylene-perfluoroalkylvinyl ether copolymer film, polyester film such as polyethylene terephthalate film, and polyimide film. Examples of metal thin-films are those made of metals such as Cr, Ti, Fe, Co, Ni, Cu, Ag, Au, Ge, Al, Mg, Sb, Pb, Pd, Cd, Bi, Sn, Se, In, Ga, Rb, etc., and oxides and nitrides of these metals. Whether single or multiple layers, the thin-film label of the present invention has a total thickness of 0.5 mil to 1.2 mil (0.0005 inch to 0.0012 inch, or 0.01 mm to 0.03 mm); however, labels as thin as 6 microns are contemplated. Accordingly, the thickness of a film of the invention is in the range of 5 μm to 50 μm or more desirably in the range of 10 μm to 30 μm. The film thickness selected is generally based upon the capability of the printing machines employed in processing the film and the film material.

Advantageously, the label of the present invention allows for unsupported thin-film label stock to be printed and directly applied to a container thereby lowering cost of the printing operation, the label, and any associated waste. Preprinting of the instant unsupported label can be carried out using any conventional printing method including, but not limited to, offset, letter press, gravure, silk screen, flexographic, digital or combinations thereof. Moreover, the instant invention is aptly suited for use in combination with reverse printing. Reverse printing is carried out by printing a reverse image on the back side of the label. When the label is applied to the container, the printed image is between the container and the label stock which protects the ink from product contact and abrasive removal during use of the package.

An unsupported label, as used in the context of the present invention, refers to a thin-film label which is not supported, or otherwise in contact with, a secondary support or carrier material which is removed upon application of the label to a container. In conventional label processing methods, such secondary supports or carrier materials are generally used to support the film or protect the tacky adhesive material of the label. In this regard, the label of the invention is adhered to the container surface by a bonding agent that is activated or otherwise applied at the point of application so a carrier material is not needed to protect the adhesive or support the film.

For the purposes of the instant invention, a label can be coated or uncoated prior to application to the container. When coated, particular embodiments embrace a label with a surface coating and/or bonding agent. Surface coatings are generally designed to provide abrasion resistance, barrier properties and optionally enhanced gloss or matte finish to the label. Such surface coatings include epoxies, urethanes, polyesters, acrylics, methacrylate resins such as polymethyl methacrylate, and combinations thereof, e.g., epoxy-modified acrylic resin, urethane-modified acrylic resin and acryl-modified polyester resin. To improve various functional characteristics, the coating can be combined with a polyacrylate resin, a polyvinyl chloride resin, a cellulosic resin, a silicone resin, chlorinated rubber, casein, various surface-active agents, wax, and metallic compounds to form a surface protective layer.

In other embodiments, the coating is a non-tacky bonding agent which can be activated at the point of application of the label to the container. Suitable bonding agents which can be activated and used in accordance with the instant labels include solvent bonding adhesives, coalescent bonding coatings or adhesives, chemical bonding adhesives, thermal bonding adhesives or thermo plastic welding of the materials.

While certain embodiments embrace the use of a bonding agent as a coating on the label, it is contemplated that the bonding agent can also be a part of the base material or coating of the container depending on the bonding agent and the means for activating the bonding agent. For example, when activation employs heat, an unsupported thin-film may be distorted and become dimensionally unstable. Therefore, it may be desirable that the bonding agent be on the container, which is more substantial and supported with a mandrel, wherein the mandrel could be cooled to create a heat sink.

Application of the unsupported thin-film label of the present invention to a container can be achieved using any suitable means. However, particular embodiments embrace the use of the bonding agent activation/application system disclosed herein. In general, the activation/application system encompasses a means for producing an unsupported, preprinted thin-film label of the invention and a means for applying or activating a bonding agent at the point of application and adhering the label to a container. Specifically, the application system of the invention applies or activates a bonding agent on the label, container, or both label and container, at the time of label application to the container. Accordingly, when the label is contacted with the container, the bonding agent creates a superior bond between the label and the container structure, which, along with the thin-film, allows the label to fully cover and conform to the container surface without lifting.

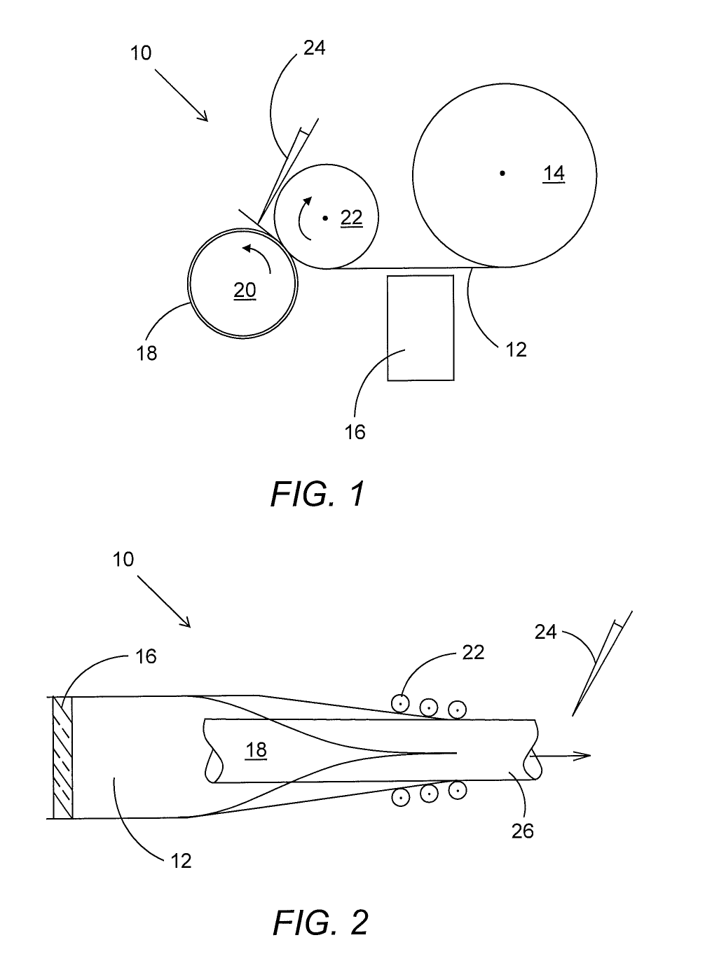

FIGS. 1-3 depict various embodiments of the bonding agent activation/application system 10 and method when the bonding agent is applied/activated on the label. For illustrative purposes, the systems are shown as applied to tube manufacturing processes. In the embodiment depicted in FIG. 1, system 10 dispenses the label 12 from a label roll 14, passes the label 12 through or near the bonding agent applicator/activator 16 and directly rolls the label 12 onto the surface of a cylindrical tube 18 (e.g., an extruded, seamed, blow molded, or impact extruded tube) loaded on a mandrel support 20. The label 12 is driven through the system 10 with one or more rubber nip rollers 22 and, upon application to the tube 18, is released from the label roll 14 with a cutter 24.

In the embodiment depicted in FIG. 2, system 10 passes the label 12 through or near the bonding agent applicator/activator 16 and wraps the label 12 onto a continuous extruded tube body 18 immediately after extrusion of the tube 18. The continuously labeled, extruded tube body 26 is driven through the system 10 with one or more nip rollers 22 and the label 12 is cut to the correct tube length with a cutter 24.

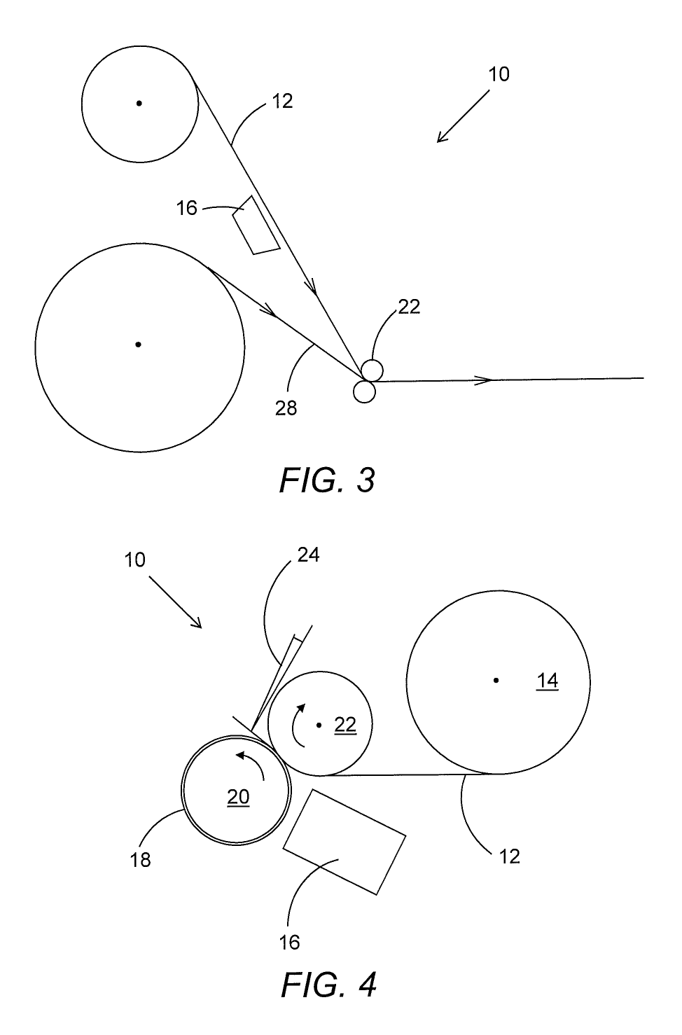

In the embodiment depicted in FIG. 3, system 10 passes the label 12 through or near the bonding agent applicator/activator 16 and applies the label 12 to a flat web stock 28. The label 12 and web stock 28 are driven through the system 10 with one or more rubber nip rollers 22 and, upon application of the label 12 to the web stock 28, the web stock can be roll formed and side-seamed into the tube cylinder.

FIGS. 4-6 depict various embodiments of the bonding agent activation/application system 10 and method when the bonding agent is applied/activated on the container. For illustrative purposes, the systems are shown as applied to tube manufacturing processes. In the embodiment depicted in FIG. 4, system 10 passes a cylindrical tube 18, loaded on a mandrel support 20, through or near the bonding agent applicator/activator 16 and directly rolls the label 12, from a label roll 14, onto the surface of the tube 18. The label 12 is driven through the system 10 with one or more rubber nip rollers 22 and, upon application to the tube 18, is released from the label roll 14 with a cutter 24.

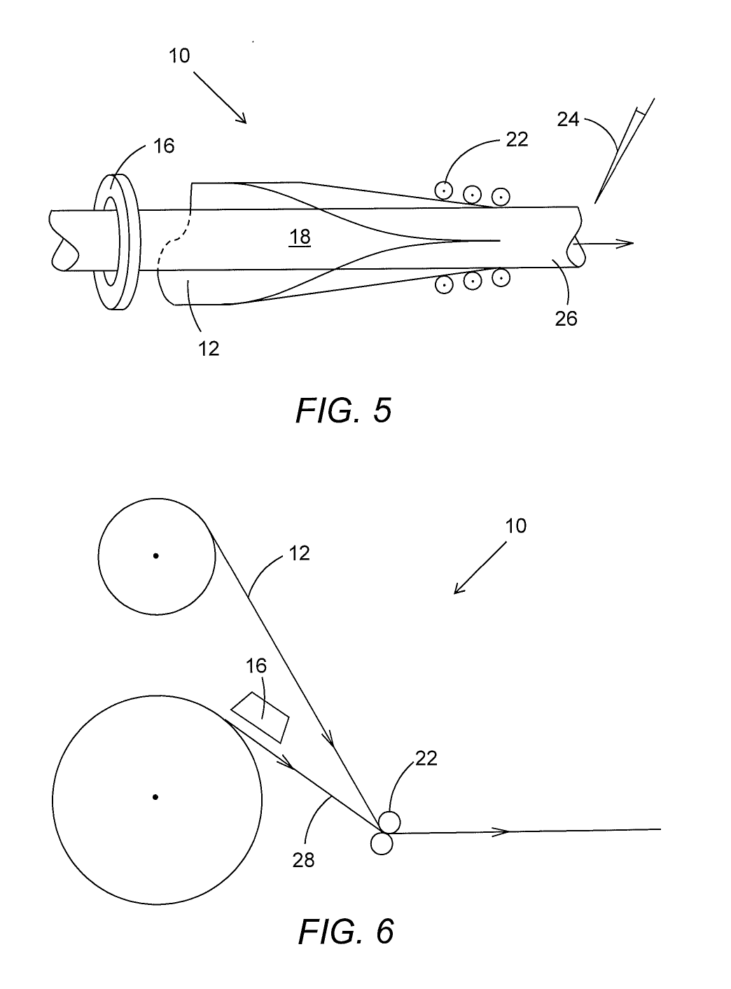

In the embodiment depicted in FIG. 5, system 10 passes a continuous extruded tube body 18 through the bonding agent applicator/activator 16 and wraps the label 12 onto the tube 18. The continuously labeled, extruded tube body 26 is driven through the system 10 with one or more nip rollers 22 and the label 12 is cut to the correct tube length with a cutter 24.

In the embodiment depicted in FIG. 6, system 10 passes a flat web stock 28 through or near the bonding agent applicator/activator 16 and applies the label 12 to directly to the flat web stock 28. The label 12 and web stock 28 are driven through the system 10 with one or more rubber nip rollers 22 and, upon application of the label 12 to the web stock 28, the web stock can be roll formed and side-seamed into the tube cylinder.

The instant label and bonding agent activation/application system find application in the manufacture of a variety of containers for consumable or purchased goods or products including consumable products such as personal care products (e.g., soaps, shampoos, make-up, insect repellents, and the like); first aid products (e.g., ointments, sunscreens, and the like); cleaners (e.g., detergents and cleaning solutions); paints; and foodstuffs (e.g., yogurt, cheese-like products, jelly, and the like). The instant method is a significant improvement in the manufacture of product containers because the product label can be applied and cut at the point of application without additional steps and carrier material waste.

What is claimed is:

1. An unsupported, preprinted, thin-film label for direct application to a container.

2. A system for application of a thin-film label comprising a means for producing an unsupported, preprinted thin-film label and a means for applying or activating a bonding agent at the point of application and adhering the label to a container.

3. A method for producing a container with a label comprising applying or activating a bonding agent on a label of claim 1 at the point of application of the label to a container and contacting the label to the container thereby producing a container with a label.
